(19) United States
(12) Patent Application Publication
(10) Pub. No.: US 2006/0047447 A1
(43) Pub. Date: Mar. 2, 2006

(54) System, method and device for monitoring an athlete

(75) Inventors: Donald Brady, Las Vegas, NV (US); Sammy I. Elhag, San Diego, CA (US); Steve Liu, San Diego, CA (US); Matthew J. Banet, Del Mar, CA (US)

Correspondence Address: Impact Sports Technologies, Inc., 2101 Plaza Del Dios, Las Vegas, NV, 89102, US

(73) Assignee: Impact Sports Technologies, Inc.

(21) Appl. No.: 11/209,159

(22) Filed: Aug. 22, 2005

Related U.S. Application Data
(60) Provisional application No. 60/604,152, filed on Aug. 24, 2004.
(60) Provisional application No. 60/609,374, filed on Sep. 13, 2004.
(60) Provisional application No. 60/619,758, filed on Oct. 18, 2004.

(51) Int. Cl. G01L 3/00; G01P 11/00; G01L 5/00; G06F 15/00

(52) U.S. Cl. 702/41; 702/149

(57) ABSTRACT

The invention provides a system, method and device which allows for real time monitoring of an athlete's performance during an athletic event, such as a boxing match or kick-boxing match, to provide a greater quantity of information to a viewer of the event. The system (9) includes a plurality of monitoring articles (10) attached to each fighter (202 and 204) and a computing device (50) positioned outside of the fighting environment (200). Each of the plurality of monitoring articles (10) preferably includes a motion sensing device (34), a microprocessor (18) and a wireless transceiver (38). The monitoring article (10) creates a real-time impact force signal for each punch or kick, which is wirelessly transmitted outside of the fighting environment (200) to a computing device (50) for processing into an impact value for transmission to and image on an electro-optical display (250).

### CROSS REFERENCE TO RELATED APPLICATIONS

The Present Application claims priority to U.S. Provisional Patent Application No. 60/604,152, filed on Aug. 24, 2004, U.S. Provisional Patent Application No. 60/609,374, filed on Sep. 13, 2004, and U.S. Provisional Patent Application No. 60/619,758, filed on Oct. 18, 2004.

### FEDERAL RESEARCH STATEMENT

Not Applicable

### BACKGROUND OF THE INVENTION

1. Field of the Invention

The present invention is generally related to monitoring an athlete's performance during an athletic event. More specifically, the present invention is related to monitoring a fighter's performance during a fight.

2. Description of Related Art

The viewers of an athletic event have always desired to have information on the athletes' performance during the event. Recently, graphical displays during televised sporting events have included: the trajectory of a hockey puck during a hockey game; the first down line during a football game; the location of birdies, bogeys and eagles for a hole during a golf tournament; and the out of bounds line during a tennis match. Further, informational displays during televised sporting events have included: the speed of a pitch during a baseball game; the speed of a serve during a tennis match; the distance of a drive during a golf tournament; and the number of punches thrown during a boxing match.

Wooster et al., U.S. Pat. No. 6,611,782 for a Real Time Boxing Sports Meter And Associated Methods, discloses a boxing glove with an embedded accelerometer that measures an impact force associated with a punch thrown in a boxing match.

Roberson, U.S. Pat. No. 2,767,920 for a Registering Boxing Glove, discloses a boxing glove with an integrated counting mechanism that utilizes a bladder built into the glove to send an impulse to a counting display when a blow is struck by a boxer wearing the glove.

Carlin, U.S. Pat. No. 4,763,284, for a Reaction Time And Force Feedback System, discloses a systems that uses a pressure transducer/strain gauge circuit connected to a boxer's limb to transmit the magnitude and time of a punch during a fight.

Klapman, U.S. Pat. No. 5,723,786, for a Boxing Glove Accelerometer, discloses an accelerometer embedded within a boxing glove to determine the force of impact of the boxing glove on an opponent.

U.S. Pat. Nos. 6,616,613 and 5,140,990 describe methods for processing information from a conventional pulse oximeter to determine blood pressure.

In addition, several issued U.S. Patents describe wrist-worn devices, having a form factor similar to a watch, which measure a user's heart rate. Representative patents include U.S. Pat. Nos. 6,747,561; 6,616,613; and 6,160,480.

Currently medical professionals use a variety of medical devices to characterize a patient's health. Such devices can measure, for example, blood pressure, blood oxygen saturation (called O₂ saturation or pulse oximetry), and heart rate, in addition to many other properties. A sphygmomanometer measures blood pressure with an inflatable cuff and sensing electronics that determine the patient's systolic and diastolic blood pressure. These devices typically feature a fitted cuff that wraps around a patient's wrist, arm or finger to measure blood pressure. During a measurement, the cuff automatically inflates and then incrementally deflates while sensing electronics (located in the cuff or in an external device) measure changes in pressure and consequently blood flow. A microcontroller in the external device then processes this information to determine blood pressure. Cuff-based blood-pressure measurements such as these typically only determine the systolic and diastolic blood pressures; they do not measure dynamic, time-dependent blood pressure. Another medical device, called a pulse oximeter, clips to the patient's finger and uses an optical system to measure heart rate and the percentage of hemoglobin in the patient's blood that is saturated with oxygen.

The modern viewer of athletic events demands a greater quantity of information for the performance of the athlete. The modern viewer wants sufficient information to determine the winner of the event without the need of a referee or a group of judges. This is especially true in boxing where the opinion of judges determines the winner if a boxer is not knocked-out, and a referee may stop a fight if the referee believes that a boxer is incapable of continuing the fight.

### SUMMARY OF THE INVENTION

The present invention allows for real time monitoring of an athlete's performance during an athletic event to provide a greater quantity of information to a viewer of the event. In a preferred embodiment, the athlete is a boxer and the athletic event is a boxing match. In an alternative embodiment, the athlete is a kick-boxer and the athletic event is a kick-boxing match.

The present invention allows the viewing public to see the physical performance of a boxer during a match, especially the performance of each punch delivered at an opponent. Further, the present invention may also allow the referee to view the vital signs of a boxer to objectively determine if the boxer can or cannot continue with the boxing match.

One aspect of the present invention is a method for real time monitoring of a match between two fighters within a fighting environment. The method begins with monitoring a plurality of strike motions of each of the fighters striking at each other during the match. Next, each of the plurality of strike motions is fitted with a fitting algorithm to determine an impact force for each of the fighters striking at each other during the match and creating an impact force signal for each of the plurality of strike motions. Next, each of the impact force signals is wirelessly transmitted to a transceiver outside of the fighting environment. Finally, each of the impact force signals is displayed as an impact value on an electro-optical display.

Another aspect of the present invention is a system for real time monitoring of a match between two fighters within a fighting environment. The system includes a plurality of monitoring articles attached to each fighter and a computing device positioned outside of the fighting environment. Each of the plurality of monitoring articles includes a motion sensing device, a microprocessor and a wireless transceiver. The motion sensing device monitors a plurality of strike motions of each of the fighters striking at each other during the match. The microprocessor receives the plurality of strike motions and fits each of the plurality of strike motions with a fitting algorithm to determine an impact force for each of the fighters striking at each other during the match to create an impact force signal. The wireless transceiver receives the impact force signal from the microprocessor and transmits the impact force signal outside of the fighting environment. The computing device includes a transceiver and a microprocessor. The transceiver receives the impact force signal from the wireless transceiver of each of the plurality of monitoring articles. The microprocessor is in communication with the transceiver and processes the impact force signal from the wireless transceiver of each of the plurality of monitoring articles into an impact value for transmission to and image on an electro-optical display.

Yet another aspect of the present invention is an article for real time monitoring of a fighter within a fighting environment. The article includes a motion sensing device, a microprocessor and a wireless transceiver. The motion sensing device monitors a plurality of strike motions of each of the fighters striking at each other during the match. The microprocessor fits each of the plurality of strike motions with a fitting algorithm to determine an impact force for each of the fighters striking at each other during the match to create an impact force signal. The wireless transceiver receives the impact force signal from the microprocessor and transmits the impact force signal outside of the fighting environment.

Yet another aspect of the present invention is a method for real time monitoring of the performance and physiology of two fighters within a fighting environment. The method begins with monitoring a plurality of strike motions of each of the fighters striking at each other during the match. Next a vital signs signal is generated for each of the fighters by monitoring the blood pressure and pulse oximetry of each fighter within the fighting environment. Next, each of the plurality of strike motions is fitted with a fitting algorithm to determine an impact force for each of the fighters striking at each other during the match and creating an impact force signal for each of the measurement signals. Next, each of the impact force signals is wirelessly transmitted to a transceiver outside of the fighting environment. Finally, each of the impact force signals is displayed as an impact value and each of the fighter's vital signs are displayed on an electro-optical display.

One aspect of the present invention is a system for real time monitoring of a match between two fighters within a fighting environment. The system includes a plurality of monitoring articles attached to each fighter and a computing device positioned outside of the fighting environment. Each of the plurality of monitoring articles includes a motion sensing device, an analog to digital converter, and a wireless transceiver. The motion sensing device monitors a plurality of strike motions of each of the fighters striking at each other during the match with a signal. The analog to digital converter converts the signal of the plurality of strike motions to a digital signal. The wireless transceiver transmits the digital signal outside of the fighting environment. The computing device includes a transceiver and a microprocessor. The transceiver receives the digital signal from the wireless transceiver of each of the plurality of monitoring articles. The microprocessor is in communication with the transceiver and processes the digital signal from the wireless transceiver of each of the plurality of monitoring articles to determine the type of punch thrown by the fighter.

Yet another aspect of the present invention is an article for real time monitoring of a fighter within a fighting environment. The article includes a motion sensing device, an analog to digital converter, and a wireless transceiver. The motion sensing device monitors a plurality of strike motions of each of the fighters striking at each other during the match with a signal. The analog to digital converter converts the signal of the plurality of strike motions to a digital signal. The wireless transceiver transmits the digital signal outside of the fighting environment to a computing device.

Yet another aspect of the present invention is a system for real time monitoring of a match between two fighters within a fighting environment. The system includes a plurality of monitoring articles integrated within gauze bandage and wrapped around the wrist and hand of each fighter and a computing device positioned outside of the fighting environment. Each of the plurality of monitoring articles includes a motion sensing device, an analog to digital converter, and a wireless transceiver. The motion sensing device monitors a plurality of strike motions of each of the fighters striking at each other during the match with a signal. The analog to digital converter converts the signal of the plurality of strike motions to a digital signal. The wireless transceiver transmits the digital signal outside of the fighting environment. The computing device includes a transceiver and a microprocessor. The transceiver receives the digital signal from the wireless transceiver of each of the plurality of monitoring articles. The microprocessor is in communication with the transceiver and processes the digital signal from the wireless transceiver of each of the plurality of monitoring articles to determine the type of punch thrown by the fighter.

Yet another aspect of the present invention is an article for real time monitoring of a fighter within a fighting environment. The article includes a motion sensing device, an analog to digital converter, and a wireless transceiver. The motion sensing device monitors a plurality of strike motions of each of the fighters striking at each other during the match with a signal. The analog to digital converter converts the signal of the plurality of strike motions to a digital signal. The wireless transceiver transmits the digital signal outside of the fighting environment to a computing device.

Yet another aspect of the present invention is a system for real time monitoring of the performance and physiology of two fighters within a fighting environment. The system includes a plurality of monitoring articles attached to each fighter and a computing device positioned outside of the fighting environment. Each of the plurality of monitoring articles includes a motion sensing device, a vital signs device for generating a vital signs signal for a blood pressure and pulse oximetry of the fighter, a microprocessor and a wireless transceiver. The motion sensing device monitors a plurality of strike motions of each of the fighters striking at each other during the match. The microprocessor fits the plurality of strike motions with a fitting algorithm to determine an impact force for each of the fighters striking at each other during the match to create an impact force signal. The wireless transceiver receives the impact force signal from the microprocessor and transmits the impact force signal and vital sign signals outside of the fighting environment. The computing device includes a transceiver and a microprocessor. The transceiver receives the impact force signal and vital sign signal from the wireless transceiver of each of the plurality of monitoring articles. The microprocessor processes the real time data from the wireless transceiver of the each of the plurality of primary monitoring articles into an impact value for each strike and a vital sign value for each fighter for transmission to and image on an electro-optical display. In a preferred embodiment, the vital sign value includes heart rate, pulse oximetry and blood pressure.

In yet another aspect of the present invention is a hand or foot-worn device which includes a motion-sensing device, a vital-sign monitor that measures multiple vital signs from a user, a microprocessor configured to receive and process information from the motion-sensing device and the vital-sign monitor, and a display, mounted on the hand or foot-worn device, that displays information from at least one of the motion-sensing device and the vital sign monitor.

Another aspect of the present invention is a system for characterizing an athlete. The system includes a hand or foot-worn device, an external computing device, and a software program. The hand or foot worn device includes a motion-sensing device, a vital-sign monitor that measures multiple vital signs from a user, a microprocessor configured to receive and process information from the motion-sensing device and the vital-sign monitor, and a first short-range wireless transceiver that transmits information from the microprocessor. The external computing device includes a second short-range wireless transceiver configured to receive information from the first short-range wireless transceiver. The software program processes information received by the second short-range wireless transceiver.

Yet another aspect of the present invention is a system for real time monitoring of the performance and physiology of two fighters within a fighting environment. The system includes means for obtaining real time performance data from a first fighter and a second fighter during the fighting event, the performance data comprising the force of a punch, means for obtaining vital sign data from a first fighter and a second fighter during the fighting event, the vital sign data comprising the heart rate of the first fighter and the second fighter, means for wirelessly transmitting the performance data and vital sign data for each of the first fighter and the second fighter to a transceiver outside of the fighting environment, and means for processing the performance data and the vital sign data for each of the fist fighter and the second fighter for display on an electro-optical display device. The vital signs data also includes at least one of a blood pressure and a pulse oximetry of each of the first fighter and the second fighter. The performance data also includes at least one of the speed of a punch, the type of a punch, the contact of a punch and time interval between punches.

Yet another aspect of the present invention is an article for real time monitoring of the performance of a fighter within a fighting environment. The article includes a motion sensing device for monitoring a plurality of strike motions of the fighter striking at an opponent during the match, a microprocessor for receiving each of the plurality of strike motions, the microprocessor fitting the each of the plurality of strike motions with a fitting algorithm to determine an impact force for each of the fighters striking at each other during the match and creating an impact force signal for each of the plurality of strike motions, the microprocessor generating a punch-type signal from the measurement signal corresponding to an uppercut or jab, and a wireless transceiver that receives the impact force signal and the punch type signal from the microprocessor and transmits the impact force signal and punch type signal outside of the fighting environment.

Yet another aspect of the present invention is a method for real time monitoring of the performance and physiology of two fighters within a fighting environment. The method commences with obtaining real time performance data from a first fighter and a second fighter during the fighting event, the performance data comprising the force of a punch. Next, vital sign data is obtained from a first fighter and a second fighter during the fighting event, the vital sign data comprising the heart rate of the first fighter and the second fighter. Next, the performance data and vital sign data for each of the first fighter and the second fighter is wirelessly transmitted to a transceiver outside of the fighting environment. Next, the performance data and the vital sign data for each of the fist fighter and the second fighter is processed for display on an electro-optical display device.

Another aspect of the present invention is a system for real time monitoring of the performance and physiology of two fighters within a fighting environment. The system includes a plurality of primary monitoring articles with each fighter having at least one of the plurality of primary monitoring articles attached to an upper limb. Each of the plurality of primary monitoring articles includes means for monitoring a plurality of strike motions of the fighter striking at an opponent during the match, means for generating a vital signs signal corresponding to the blood pressure and pulse oximetry of each fighter, means for communicating with the monitoring means and fitting each of the plurality of strike motions with a fitting algorithm to determine an impact force for each of the fighter's strikes at an opponent during the match and creating an impact force signal for each of the plurality of strike motions, and means for transmitting the impact force signal and the vital sign signal outside of the fighting environment. The system also includes a computing device positioned outside of the fighting environment. The computing device includes means for receiving the impact force signal and the vital sign signal from each of the plurality of monitoring articles, and means for processing the impact force signal from the wireless transceiver of each of the plurality of monitoring articles into an impact value for each strike and a vital sign value for each fighter for transmission to and image on an electro-optical display.

Another aspect of the present invention is an article for real time monitoring of the performance and physiology of a fighter within a fighting environment. The article includes a motion sensing device, a vital signs device, a microprocessor and a wireless transceiver. The motion sensing device monitors a plurality of strike motions of each of the fighters striking at each other during the match. The vital signs device generates a vital sign signal for the blood pressure and pulse oximetry of the fighter. The microprocessor receives each of the plurality of strike motions and fits each of the plurality of strike motions with a fitting algorithm to determine an impact force for each of the fighters striking at each other during the match and creates an impact force signal for each of the plurality of strike motions. The wireless transceiver receives the impact force signal and the vital signs signal from the microprocessor and transmits the impact force signal and vital signs signal outside of the fighting environment.

Another aspect of the present invention is a system for real time monitoring of the performance and physiology of two fighters within a fighting environment. The system includes a plurality of primary monitoring articles and a computing device. Each fighter has at least one of the plurality of primary monitoring articles attached to an upper limb. Each of the plurality of primary monitoring articles includes a motion sensing device, a vital signs device, a microprocessor and a wireless transceiver. The motion sensing device monitors a plurality of strike motions of each of the fighters striking at each other during the match. The vital signs device generates a vital sign signal for the blood pressure and pulse oximetry of the fighter. The microprocessor receives each of the plurality of strike motions and fits each of the plurality of strike motions with a fitting algorithm to determine an impact force for each of the fighters striking at each other during the match and creates an impact force signal for each of the plurality of strike motions. The wireless transceiver receives the impact force signal and the vital signs signal from the microprocessor and transmits the impact force signal and vital signs signal outside of the fighting environment. The computing device is positioned outside of the fighting environment and includes a transceiver for receiving the real time data from the wireless transceiver of each of the plurality of primary monitoring articles and a microprocessor in communication with the transceiver. The microprocessor processes the real time data from the wireless transceiver of the each of the plurality of primary monitoring articles into an impact value for each strike and a vital sign value for each fighter for transmission to and image on an electro-optical display.

Another aspect of the present invention is a system for real time monitoring of the performance and physiology of two fighters within a fighting environment. The system includes a plurality of primary monitoring articles, a plurality of secondary articles and a computing device. Each fighter has one of the plurality of primary monitoring articles attached to one upper limb and one of the plurality of secondary monitoring articles attached to a second upper limb. Each of the plurality of primary monitoring articles and secondary monitoring articles includes a motion sensing device, a vital signs device, a microprocessor and a wireless transceiver. The motion sensing device monitors a plurality of strike motions of each of the fighters striking at each other during the match. The vital signs device generates a vital sign signal for the blood pressure and pulse oximetry of the fighter. The microprocessor receives each of the plurality of strike motions and fits each of the plurality of strike motions with a fitting algorithm to determine an impact force for each of the fighters striking at each other during the match and creates an impact force signal for each of the plurality of strike motions. The wireless transceiver receives the impact force signal and the vital signs signal from the microprocessor and transmits the impact force signal and vital signs signal outside of the fighting environment. The computing device is positioned outside of the fighting environment and includes a transceiver for receiving the real time data from the wireless transceiver of each of the plurality of primary monitoring articles and a microprocessor in communication with the transceiver. The microprocessor processes the real time data from the wireless transceiver of the each of the plurality of primary monitoring articles and secondary monitoring articles into an impact value for each strike and a vital sign value for each fighter for transmission to and image on an electro-optical display.

Another aspect of the present invention is an article for real time monitoring of the physiology of a fighter within a fighting environment. The article includes a vital signs device, a microprocessor and a wireless transceiver. The vital signs device generates a vital sign signal for the blood pressure and pulse oximetry of the fighter. The microprocessor receives the vital sign signal and processes it. The wireless transceiver receives the processed vital signs signal from the microprocessor and transmits the vital signs signal outside of the fighting environment.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF SEVERAL VIEW OF THE DRAWINGS

FIG. 1 is a systematic diagram of a preferred embodiment of the present invention.

FIG. 2 is a schematic top plan view of a fighting event utilizing the present invention.

FIG. 3 is an isolated view of the monitoring device and computing device of the system.

FIG. 4 is a front play view of a preferred embodiment of the monitoring device of the present invention

FIG. 5 is a schematic side view of a boxing glove with a monitoring device of the present invention integrated therein.

FIG. 5A is a schematic front view of a boxing glove with a monitoring device of the present invention integrated therein.

FIG. 6 is an isolated perspective view of a monitoring device of the present invention.

FIG. 7 is an enlarged view of an integrated monitoring device within a boxing glove.

FIG. 8 is an image of a menu of the software of the computing device of the present invention.

FIG. 9 is an isolated image of a sample vector's section of the menu of FIG. 8.

FIG. 10 is an isolated image of an action history section of the menu of FIG. 8.

FIG. 11 is an isolated image of an action performed section of the menu of FIG. 8.

FIG. 12 is an isolated image of a calculated difference section of the menu of FIG. 8.

FIG. 13 illustrates a graphical display television.

FIG. 14 is a flow chart of a preferred method of the present invention.

FIG. 15 is an enlarged view of an integrated monitoring device within a gauze bandage.

FIG. 16 is a plan view of a boxer's hand wrapped in a gauze bandage with a monitoring article integrated therein.

FIG. 17 is a schematic front view of a boxing glove with force sensors integrated therein.

FIG. 18 is an isolated view of an impact area of the glove of FIG. 17 with force sensors.

FIG. 19 is an image of voltage readouts from the force sensors.

FIG. 20 is an image of a scaled number of the force from the force sensors.

FIG. 21 is a bar graph of the force from the force sensors.

FIG. 22 is an isolated system diagram of an alternative embodiment of a system.

FIG. 23 is a schematic view of circuit components used in the monitoring article of FIG. 22.

FIG. 24 is a graph showing a signal from an accelerometer imbedded within the monitoring article of FIG. 22, along with a simulation from a mathematical model that ‘fits’ the signal.

### DETAILED DESCRIPTION OF THE INVENTION

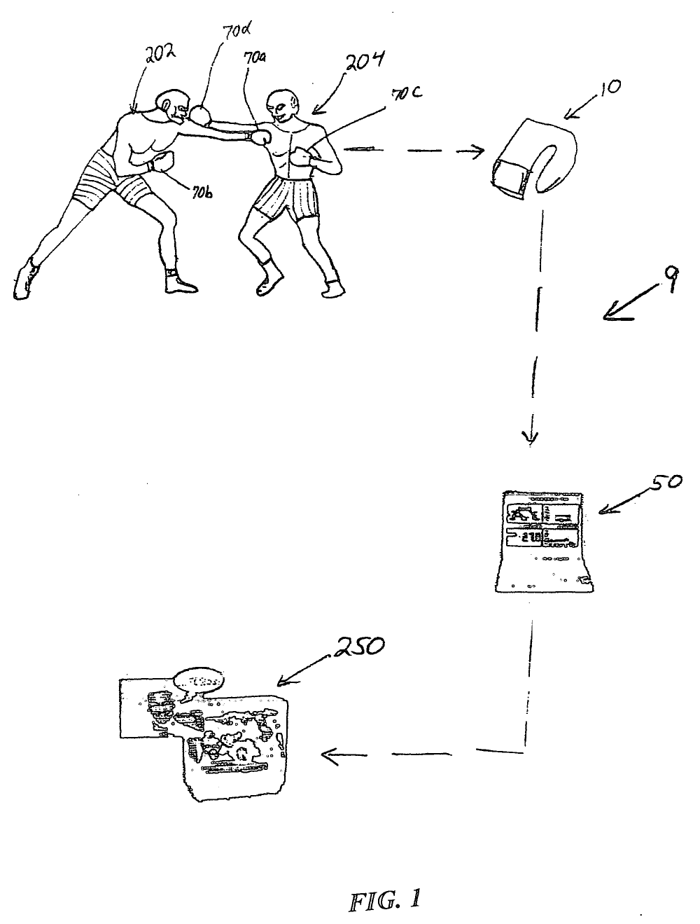

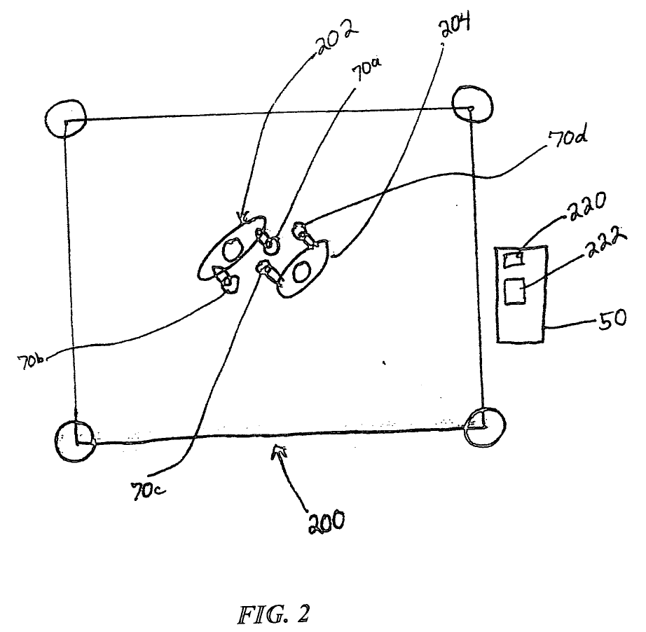

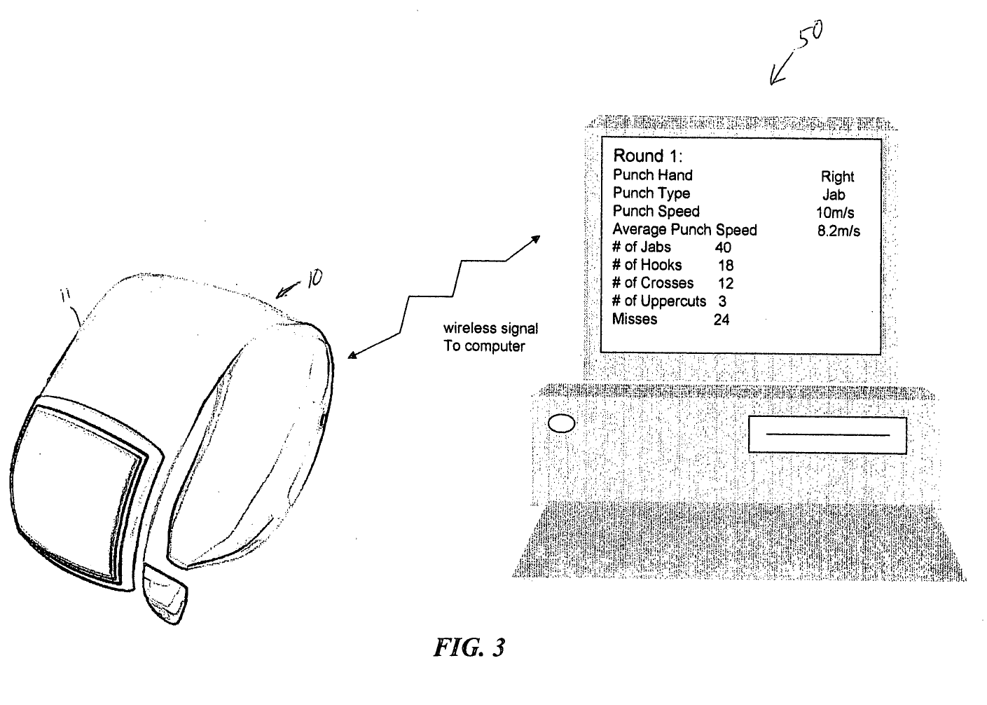

As shown in FIGS. 1-3, the system 9 on the invention generally includes a plurality of monitoring articles attached to athletes, a computing device 50 and optionally an electro-optical display. In a preferred embodiment, a first fighter 202 has a first monitoring article 10 positioned under a cuff of a first glove 70a and a second monitoring article 10 positioned under a cuff of a second glove 70b. Likewise, a second fighter 204 has a first monitoring article 10 positioned under a cuff of a first glove 70c and a second monitoring article 10 positioned under a cuff of a second glove 70d.

Each of the monitoring articles preferably comprises an embedded, multi-axis accelerometer 34 that detects general motion and rapid acceleration and deceleration of the user's hand. In a typical application, a boxer 202 wears the monitoring articles 10 during a boxing match within a fighting environment 200 such as a boxing ring. The accelerometer 34 measures a plurality of information for a plurality of punches of the boxer. The information is transmitted to a microcontroller were an analog to digital converter 46 converts the signal. A short-range wireless transmitter 38 sends this information to a nearby computing device 50, such as a laptop computer or a hand-held device (e.g., a cell phone or personal digital assistant), for further processing. In this way, the monitoring articles 10 and the computing device 50 (or hand-held device) collectively form a system 9 that can characterize, in real-time, both the performance and optionally physiological condition of an athlete, of an athlete such as a boxer engaged in a sporting event.

More specifically, the monitoring device 10 having a two or three axis accelerometer 34 is mounted in a boxing glove 70 on a wrist worn cuff 11. A voltage representative of acceleration is preferably converted to a digital signal by the analog to digital converter 46. The digital signal is transmitted by the short range wireless transmitter 38 to the computing device 50. The data is processed using a plurality of parameters, a known wave-form and optionally a statistical model to determine the most likely “action” performed whether the action is a punch a kick or other motion.

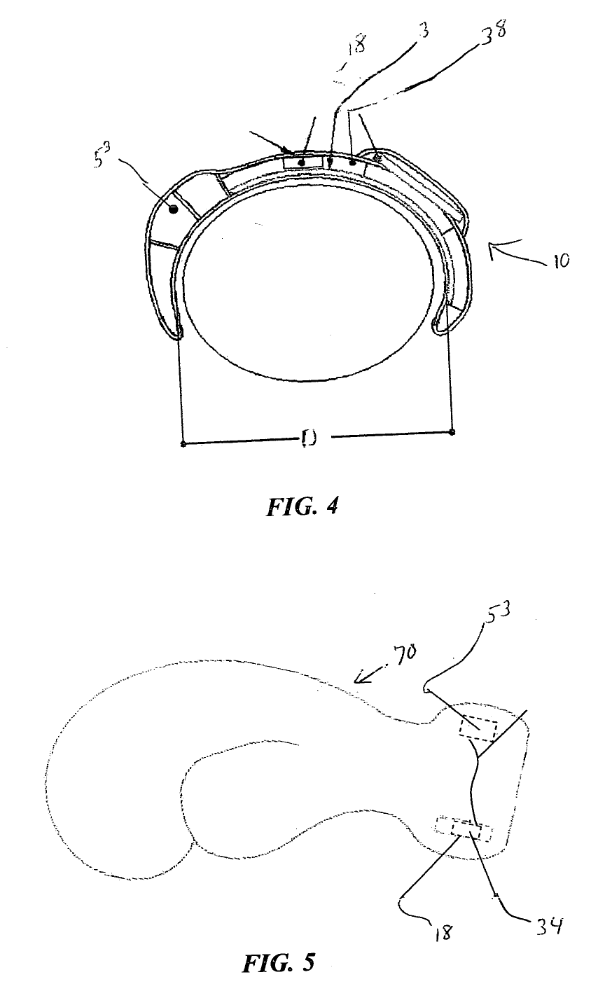

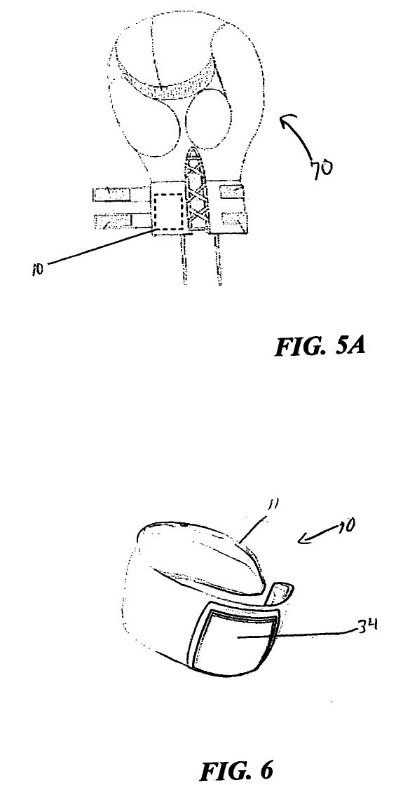

To measure motion and impact forces, a monitoring device 10 is set forth as a unitary cuff 11 as shown in FIGS. 4 and 6, or the monitoring device 10 is integrated into a boxing glove 70 such as shown in FIGS. 5 and 5A. Using the short-range wireless link 26, the monitoring article 10 transmits information relating to motion of an athlete's limb to the laptop computer 50 or hand-held device 51 (e.g., a cellular phone or personal digital assistant) at a periodic interval, or following an event, such as a thrown punch. The laptop computer 50 or hand-held device 51, in turn, runs a software program that monitors and further processes information concerning the athlete.

The short-range wireless transmitter 38 within the monitoring article 10 preferably includes a transmitter operating on a wireless protocol, e.g. Bluetooth™, part-15, or 802.11. In this case, ‘part-15’ refers to a conventional low-power, short-range wireless protocol, such as that used in cordless telephones. In typical embodiments, the short-range wireless transmitter 38 sends information to an external, secondary wireless component, included in the external computing device 50, which includes a matched short-range wireless receiver 220 that operates on a complementary protocol and a microprocessor 222. The computing device 50 may also include a long-range wireless transmitter that transmits information over a terrestrial, satellite, or 802.11-based wireless network. Suitable networks include those operating at least one of the following protocols: CDMA, GSM, GPRS, Mobitex, DataTac, iDEN, and analogs and derivatives thereof.

Typically, the wireless transmitter 38 sends information following an ‘event’, such as when a punch is thrown. The monitoring article 10 may include data-processing firmware, running on an internal, embedded microprocessor 18, that detects such an event. The firmware can also process signals from the vital-sign monitor, as is described in more detail below.

The term ‘microprocessor’, as used herein, generally means a silicon-based microprocessor or microcontroller that can run compiled computer code to perform mathematical operations on data stored in a memory. Examples include ARM7 or ARM9 microprocessors manufactured by a number of different companies; AVR 8-bit RISC microcontrollers manufactured by Atmel; PIC CPUs manufactured by Microchip Technology Inc.; and high-end microprocessors manufactured by Intel and AMD.

Software programs on the microprocessor of the computing device 50 may be further integrated with other software programs, such as a punch-counting software program developed by Compubox of Manorville, N.Y. With this program an operator records the number of punches landed and missed by a boxer during a boxing match. This program further processes this information to provide a statistical analysis and televised display for boxing matches.

The athletic-monitoring system 9 measures cardiac, motion, and impact force information non-invasively with basically no inconvenience to the athlete. This means information can be measured in real time during an athletic event, e.g. a boxing match. In this case, the laptop computer 50 or hand-held device 51 would be stationed just outside the ring 200 of the match. According to the World Boxing Association (“WBA”) rules (specifically Section 14), the ring should be from eighteen feet to twenty-four feet with an eighteen inches extent beyond the ropes of the ring. Further, WBA rules (specifically Section 10) specify that boxing gloves should have a mass of ten ounces for superwelterweight class to heavyweight class, and eight ounces up to welterweight class. The bandage wrapped around a boxer's wrist should be ten yards of two inches wide, soft gauze, which relevant to the alternative embodiment discussed below.

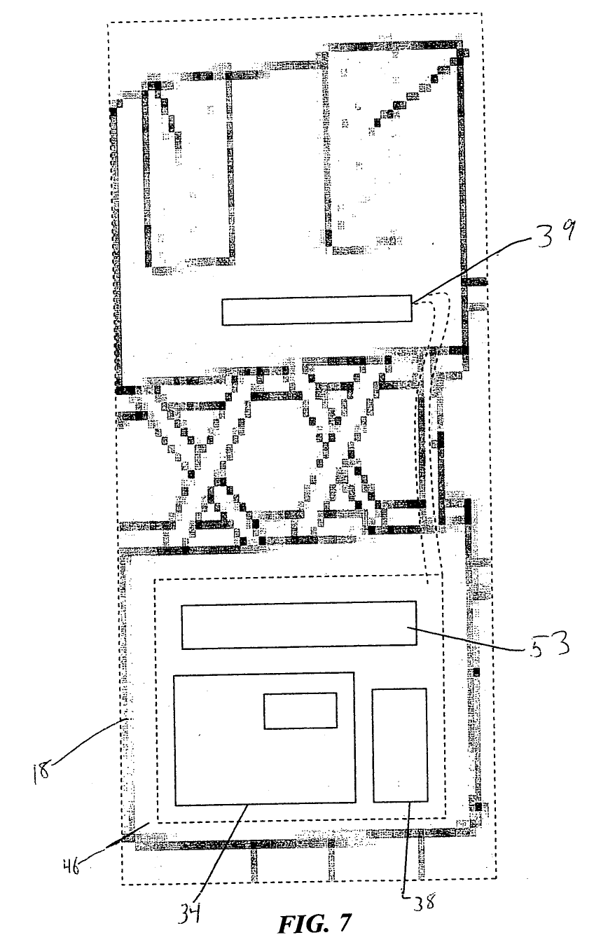

FIG. 7 illustrates the preferred electronic components featured in the monitoring article 10 when integrated into a boxing glove 70. The accelerometer 34 connects to an analog-to-digital converter 46 within a motherboard 18 to measure a plurality of information as discussed in further detail below. Specifically, the analog-to-digital converter 46 samples the variable voltage generated by the accelerometer 34, and in response generates a time-dependent voltage value that is sent to the short-range wireless transmitter 38 and then transmitted to the computing device 50 for further processing as discussed below. A battery 53 provides power to each of the accelerometer 34, transmitter 38 and motherboard 18 with the analog to digital converter 46.

The short-range wireless transmitter 38 (e.g., a BLUETOOTH™ transmitter) receives information from the data-processing circuit 18 and transmits this information in the form of a packet through an antenna 39. The external laptop computer or hand-held device (not shown in the figure) features a similar antenna coupled to a matched wireless, short-range receiver 50 that receives the packet. In certain embodiments, the hand-held device is a cellular telephone with a BLUETOOTH™ circuit integrated directly into a chipset used in the cellular telephone. In this case, the cellular telephone may include a software application that receives, processes, and displays the information.

The output of the accelerometer 34 is in duty cycles. At 50% duty cycle, the respective axis X, Y, and Z are at zero. If the duty cycle is increased, there is an acceleration in the positive direction. While a decrease will represent the acceleration in the negative direction. The software of the present invention uses the output from the accelerometer and translates this output into four different parameters. The first and basic parameter is the average position of the X, Y and Z axis. The two most important factors in determining a punch type is the absolute value of the change of the X, Y and Z, and the range of X, Y and Z. For example, a jab and a hook have significantly different patterns because a jab accelerates fast, and the time it takes to throw and return to an at rest position is short. Conversely, a hook lasts longer and covers more range than a jab. The accelerometer 34 alternatively provides an output in voltage (0-5 volts). In this alternative, zero will be at 2.5 volts as opposed to 50% duty cycle.

A statistical model is optionally used to characterize and determine punch type more accurately. The software will sample different points over a period of time during the motion of a punch and store the results in a database. If a particular punch is thrown, the software will map these points to the closest recorded punch. For example, if 70% of the points lie within a certain punch, the software will determine the motion to be that type of punch. In the general case for boxing, there are four types of punches: 1) jab; 2) hook; 3) uppercut; and 4) cross.

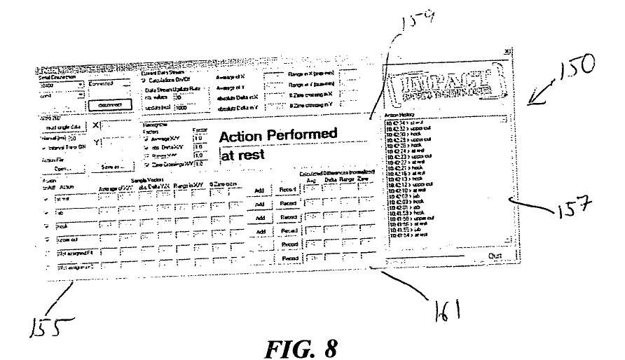

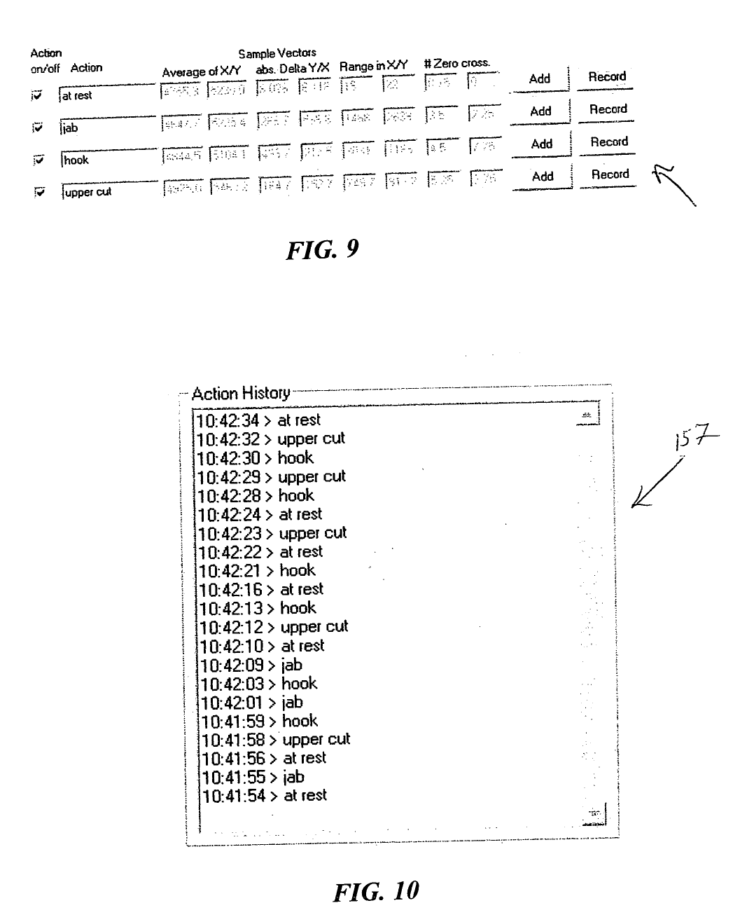

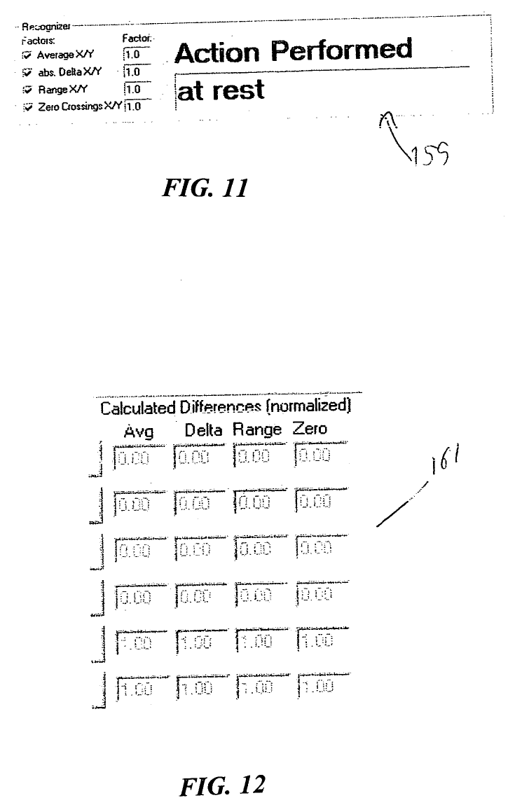

FIG. 8 is an image of a menu 150 for the computing device 50. As shown in FIGS. 8-12, the menu contains sections for data received from transmitter 38 of the monitoring device 10. A sample vectors section 155 for a two axes accelerometer has information on the average position of the X and Y axis, the absolute value of the change of the X and Y, the range of X and Y, and the zero cross for each type of punch and at rest. A sample vectors section 155 for a three axes accelerometer has information on the average position of the X, Y and Z axis, the absolute value of the change of the X, Y and Z, the range of X, Y and Z, and the zero cross for each type of punch and at rest. This information is usually recorded prior to an athlete event as comparison information for each fighter. For example, a fighter would throw a pre-fight jab and the monitoring device would capture the information for the type of punch and it would be recorded on the computer device for use later during the fight. A history section 157 displays the history of punches at time of each punch. An action performed section 159 displays the plurality of information (four parameters) obtained for the current punch: the average position of the X and Y axis, the absolute value of the change of X and Y, the range of X and Y, and the zero cross. A calculated differences section 161, the calculated differences for the recorded information and the monitored information is displayed. In this manner, the present invention is able to determine the type of punch thrown during a fight in real time.

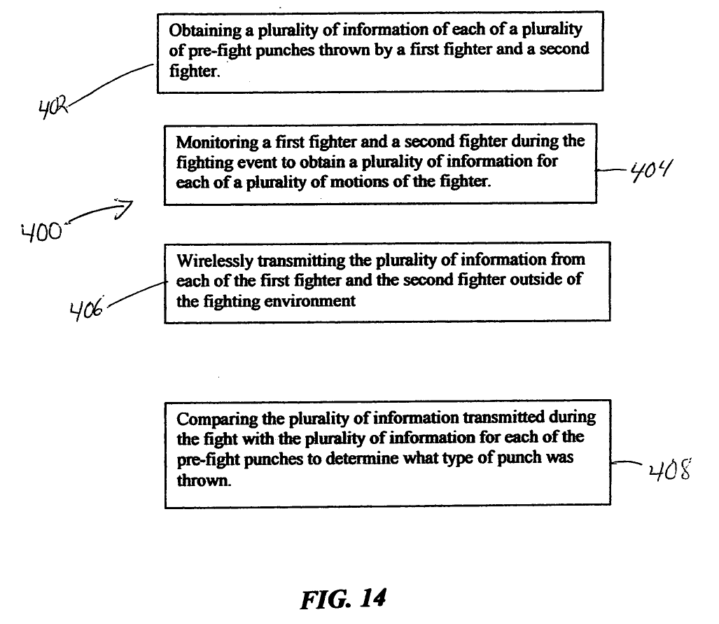

FIG. 14 illustrates a flow chart of a general method 400. At block 402, a plurality of information is obtained for a plurality of pre-fight punches for each of a first fighter 202 and a second fighter 204. At block 404, the fighters are monitored during the fighting event and within the fighting environment 200. A plurality of information for each of a plurality of motions of each of the fighters limbs are obtained by accelerometers, each of which is located in proximity to a boxer's glove 70. At block 406, the plurality of information for each of the first fighter 202 and the second fighter 204 is wirelessly transmitted outside of the fighting environment 200. At block 408, the plurality of information obtained during the fight is compared to the plurality of information for a plurality of pre-fight punches to determine what type of punch was thrown by a fighter. The information is processed for display on an electro-optical display device 250.

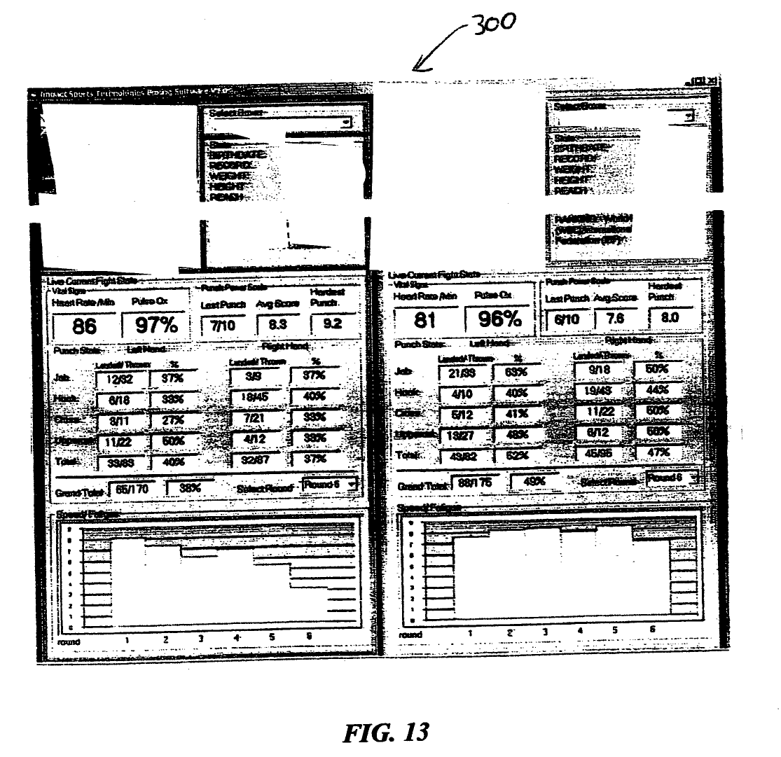

FIG. 13 illustrates a graphical display 300 for display on television or a computer screen. The graphical display illustrates the preferred information that is provided by system 9. For example, the system 9 can determine if a punch is a jab, hook, cross or uppercut, and can determine if contact was made by the fighter. Further, the system 9 can total the amount of punches of each category. Additionally, the system can provide the speed of the punch, the impact force and the physiology of the boxer.

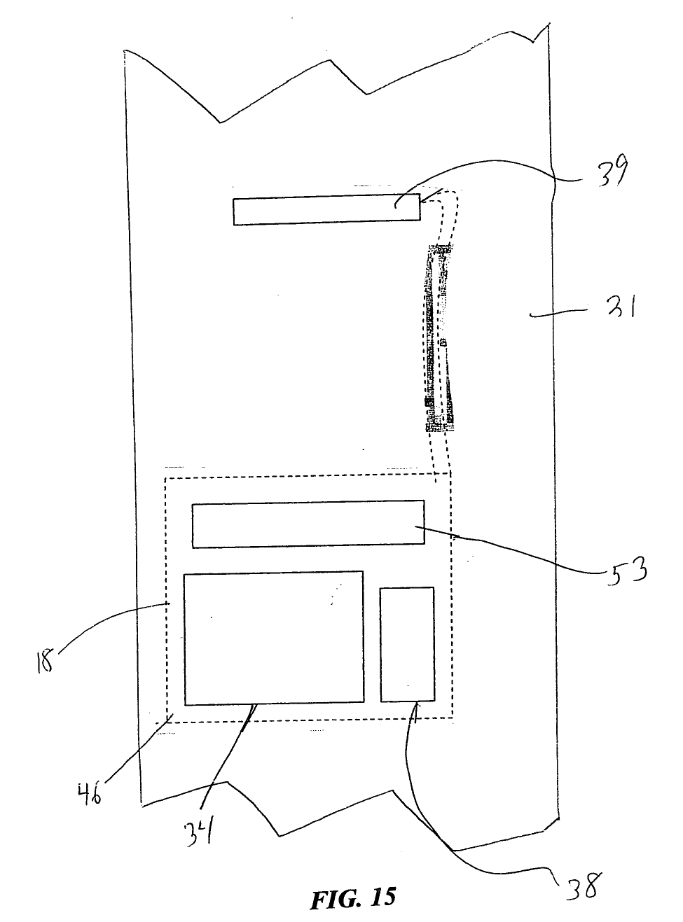

In an alternative embodiment of FIGS. 15-21, each of the monitoring articles 10 is a gauze bandage 21 with monitoring components integrated therein. The gauze bandage 21 is as close as possible to the standard gauze bandage utilized by fighters during a boxing match. The bandage wrapped around a boxer's wrist should be ten yards of two inches wide, soft gauze. As stated previously, WBA rules (specifically Section 10) specify that boxing gloves should have a mass of ten ounces for superwelterweight class to heavyweight class, and eight ounces up to welterweight class. In this alternative embodiment, a first fighter 202 has a first monitoring article 10 positioned under a cuff of a first glove 70a and a second monitoring article 10 positioned under a cuff of a second glove 70b. Likewise, a second fighter 204 has a first monitoring article 10 positioned under a cuff of a first glove 70c and a second monitoring article 10 positioned under a cuff of a second glove 70d.

The monitoring device 10 preferably has a two or three axis accelerometer 34 integrated into the gauze bandage 21. A voltage representative of acceleration is preferably converted to a digital signal by the analog to digital converter 46, which is also preferably integrated into the gauze bandage 21. The digital signal is transmitted by the short range wireless transmitter 38 to the computing device 50. The short range wireless transmitter 38 is also integrated into the gauze bandage 21. The data is processed using a plurality of parameters, a known wave-form and optionally a statistical model to determine the most likely “action” performed.

To measure motion and impact forces, a monitoring device 10 is integrated into the gauze bandage as shown in FIG. 15. Using the short-range wireless link 26, the monitoring article 10 transmits information relating to motion of an athlete's limb to the laptop computer 50 or hand-held device 51 (e.g., a cellular phone or personal digital assistant) at a periodic interval, or following an event, such as a thrown punch. The laptop computer 50 or hand-held device 51, in turn, runs a software program that monitors and further processes information concerning the athlete.

FIG. 15 illustrates the preferred electronic components featured in the monitoring article 10 when integrated into the gauze bandage 21. Alternatively, each of the components of the monitoring article 10 is wrapped individually by gauze bandage 21 around a fighter's wrist. The accelerometer 34 preferably connects to an analog-to-digital converter 46 within a motherboard 18 to measure a plurality of information as discussed in further detail below. Specifically, the analog-to-digital converter 46 samples the variable voltage generated by the accelerometer 34, and in response generates a time-dependent voltage value that is sent to the short-range wireless transmitter 38 (e.g., a BLUETOOTH™ transmitter) and then transmitted by an antenna 39 to the computing device 50 for further processing as previously discussed. A battery 53 provides power to each of the accelerometer 34, short-range wireless transmitter 38 and motherboard 18 with the analog to digital converter 46.

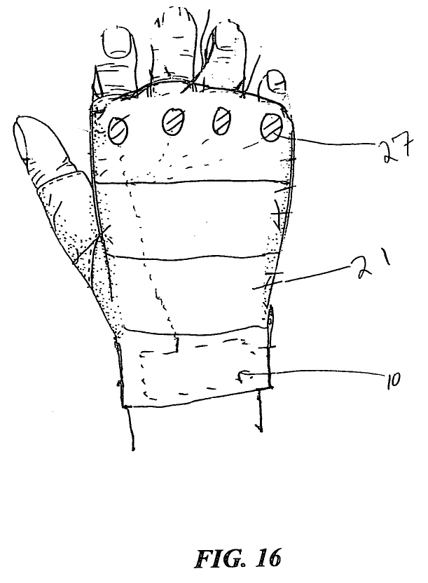

FIG. 16 illustrates a hand of a boxer wrapped in the gauze bandage 21. Typically, tape is wrapped around the gauze bandage to maintain the gauze bandage in position on the fighter's hand and wrist. A plurality of force sensors 27 are positioned on the boxer's fingers in an area likely to involve impact during a punch. A preferred force sensor is a FLEXIFORCE sensor from TEKSCAN of South Boston, Mass., and as described in U.S. Pat. No. 6,272,936 which is hereby incorporated by reference in its entirety. Approximately five volts of electricity is supplied to a force sensor 27. The more force, the more return voltage. The signal from each sensor 27 is sent to the analog-to-digital converter 46. The return voltage may be scaled to distinguish between punches. In this manner, the force of each punch is determined during the boxing match.

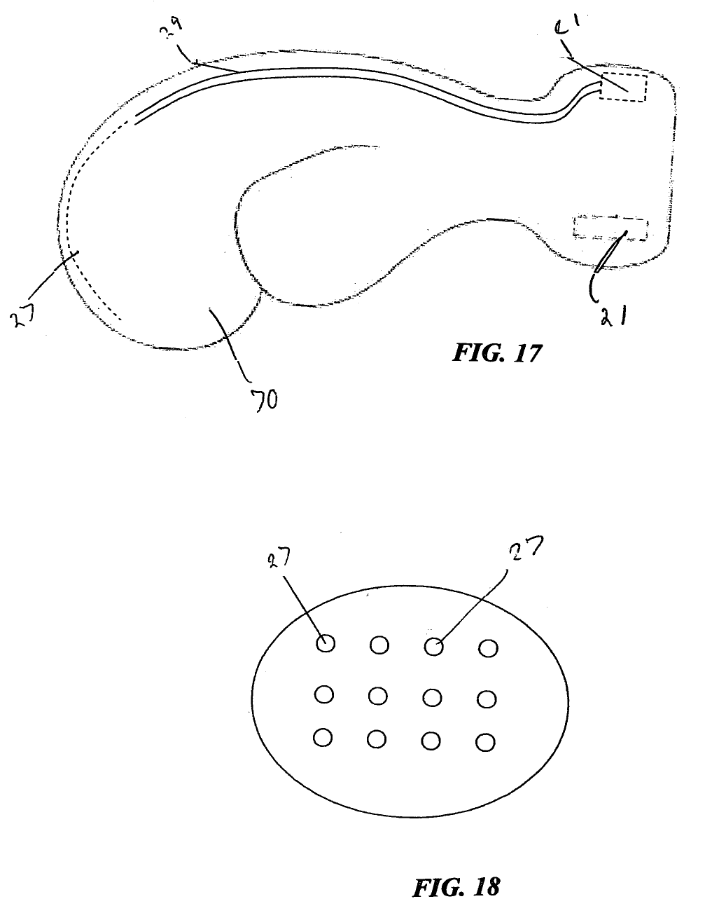

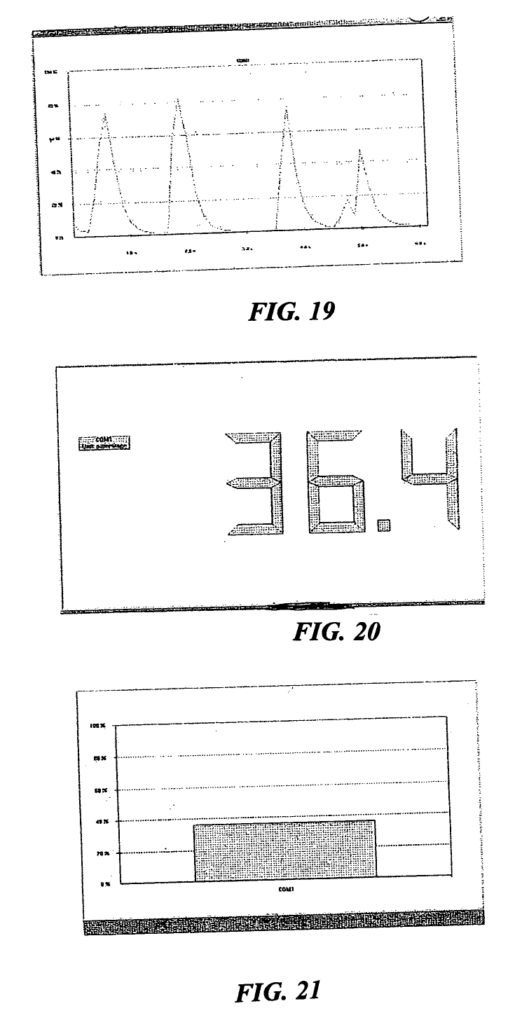

Alternatively, as shown in FIGS. 16 and 17, the force sensors 27 are integrated within the glove 70 and connected to the other components of the monitoring article 10 within the gauze bandage 21 by a wire 29. FIGS. 19-21 illustrate the possible displays of the force of impact for each punch as measured by the force sensors 27. FIG. 19 illustrates the voltage spikes. FIG. 20 is a scaled number readout, which can be in pounds, kilograms, Newtons or just highest to lowest. FIG. 21 illustrates a bar graph of the readout. The information is processed and displayed as set forth above in reference to FIGS. 8-14.

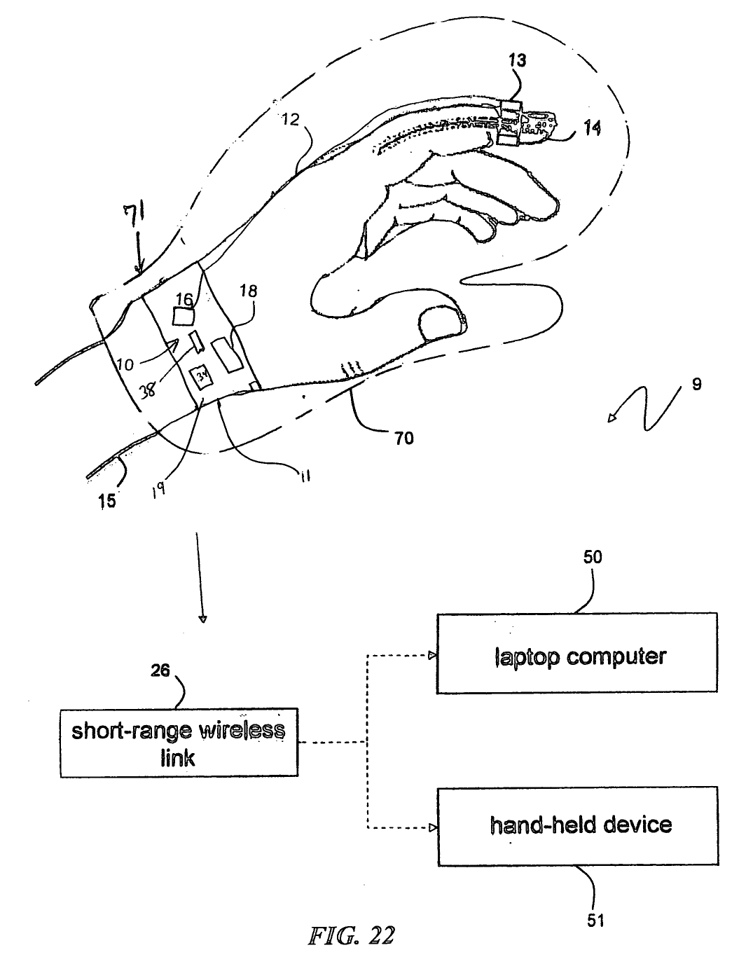

FIG. 22 illustrates another alternative embodiment of the athletic-monitoring system 9 that measures vital signs, motion, and impact forces from an athlete's wrist 15 while being worn under a boxing glove 70 (shown in dashed lines). The system 9 preferably includes a monitoring article 10 that measures and then wirelessly transmits these properties through a short-range wireless link 26 to the external laptop computer 50 or hand-held device 51 for further processing with a software program stored in a memory. In this embodiment, the monitoring article 10 preferably includes a wrist-mounted module 11 that attaches to an area of the athlete's wrist 15 where a watch is typically worn, and a finger-mounted module 13 that attaches to the athlete's index finger 14. Preferably a cable 12 provides an electrical connection between the finger-mounted module 13 and wrist-mounted module 11.

To measure motion and impact forces, the wrist-mounted module 11 features an embedded multi-axis accelerometer 34 that senses acceleration, deceleration, and general motion, and sends this information to a data-processing circuit 18. In a complementary manner, the finger-mounted module 13 measures information that is processed to determine the athlete's vital signs. Specifically, a vital-signs monitor 16 embedded in the wrist-mounted module 11 connects to the finger-mounted module 13, which measures blood flow in the athlete's finger, and sends this information through the cable 12 to the wrist-mounted module 11. During operation, the finger-mounted module 13 measures an optical ‘waveform’ that is processed, as described detail below, to determine diastolic and systolic blood pressure, real-time beat-to-beat blood pressure, heart rate, and pulse oximetry.

Using the short-range wireless link 26, the monitoring article 10 transmits information relating to motion and vital signs to the laptop computer 50 or hand-held device 51 (e.g., a cellular phone or personal digital assistant) at a periodic interval, or following an event, such as a thrown punch. The laptop computer 50 or hand-held device 51, in turn, runs a software program that monitors and further processes information concerning the athlete, including displaying the information on a optoelectronic display device.

In this alternative embodiment, the accelerometer 34 is preferably a multiple-axis accelerometer, such as the ADXL202 made by Analog Devices of Norwood, Mass. This device is a standard micro-electronic-machine (“MEMs”) module that measures acceleration and deceleration using an array of silicon-based structures. The vital-sign monitor 16 preferably comprises a finger-mounted component, such as an annular ring, that attaches to circuitry within a bracelet 19. The finger-mounted module 13 houses a miniature optical module that measures blood pressure, pulse oximetry and heart rate, such as described in detail in U.S. patent application Ser. No. 10/752,198 for a Wireless, Internet-Based Medical Diagnostic System, which was filed on Jan. 6, 2004, U.S. patent application Ser. No. 10/709,015 for a Cuffless Blood-Pressure Monitor And Accompanying Wireless, Internet Based System, which was filed on Apr. 7, 2004, U.S. patent application Ser. No. 10/709,014 for a Cuffless System For Measuring Blood Pressure, which was filed on Apr. 7, 2004, and U.S. patent application Ser. No. 10/810,237 for a Cuffless Blood Pressure Monitor And Accompanying Web Services Interface, which was filed on Mar. 26, 2004, all of which are hereby incorporated by reference in their entireties.

The short-range wireless transmitter 38 within the monitoring article 10 is as described above. The short-range wireless transmitter 38 sends information to an external, secondary wireless component, included in the external computing device 50, which includes a matched short-range wireless receiver that operates on a complementary protocol and a microprocessor. The computing device 50 may also include a long-range wireless transmitter that transmits information over a terrestrial, satellite, or 802.11-based wireless network. Suitable networks include those operating at least one of the following protocols: CDMA, GSM, GPRS, Mobitex, DataTac, iDEN, and analogs and derivatives thereof.

By characterizing both motion and vital signs in real-time, the monitoring article 10 monitors performance and the physiological performance of athletes, such as boxers, participating in actual sporting events. For example, the force-measuring sensors can quantify the number of magnitude of the punches thrown by the boxer, while sensors within the vital-sign monitor 16 measure the boxer's health and level of fatigue. Measurements can be made completely unobtrusive to the athlete without affecting their performance. Trends in the athlete's performance, such as a decrease in punch intensity, an increase in heart rate, or a sudden drop in pulse oximetry, can be easily determined with the external computer. Algorithms running on this computer can further process this information to monitor additional properties concerning the boxer's effectiveness and health, and display them as discussed above in reference to the other embodiments.

In addition, the software programs can further analyze the athlete's blood pressure, and heart rate, and pulse oximetry values to characterize the their cardiac condition. These programs, for example, may provide a report that features statistical analysis of these data to determine averages, data displayed in a graphical format, trends, and comparisons to doctor-recommended values.

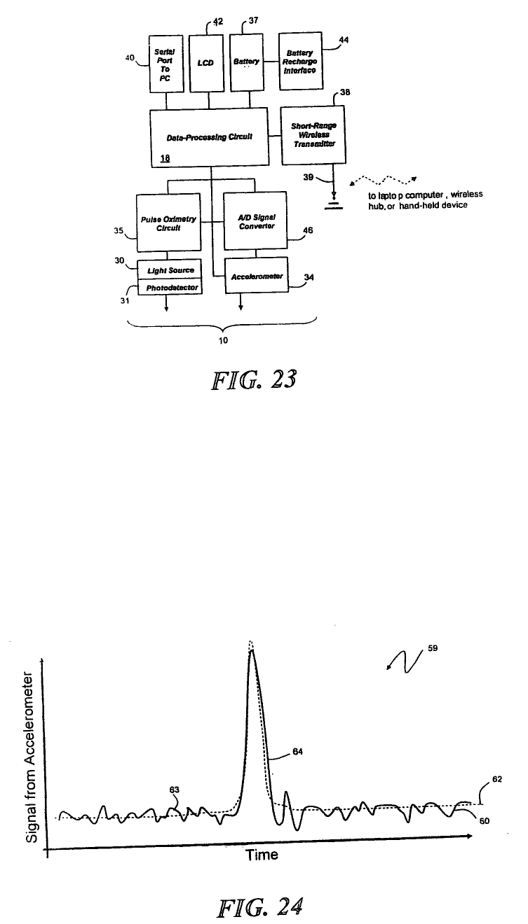

FIG. 23 illustrates electronic components featured in the monitoring article 10 of the embodiment of FIG. 22. The accelerometer 34 connects to an analog-to-digital converter 46 within a data-processing circuit 18 to measure motion, acceleration, and deceleration of the athlete's wrist. Specifically, the analog-to-digital converter 46 samples the variable voltage generated by the accelerometer 34, and in response generates a time-dependent voltage value that the data-processing circuit 18 receives, preferably stores in an internal memory, and then analyzes with a microprocessor as described above.

To generate an optical waveform and measure blood pressure, pulse oximetry, heart rate, along with various statistics (e.g., average values, standard deviation) of this information, the monitoring article 10 includes a light source 30 and a photodetector 31 embedded within the finger-mounted module 13. The light source 30 typically includes light-emitting diodes that generate both red (λ˜630 nm) and infrared (λ˜900 nm) radiation. As the heart pumps blood through the patient's finger, blood cells absorb and transmit varying amounts of the red and infrared radiation depending on how much oxygen binds to the cells' hemoglobin. The photodetector 31 detects transmission at the red and infrared wavelengths, and in response preferably generates a radiation-induced current that travels through a cable to a pulse-oximetry circuit 35 embedded within the wrist-worn module. The pulse-oximetry circuit 35 connects to the analog-to-digital signal converter 46 that converts the radiation-induced current into the time-dependent optical waveform, which is then sent back to the pulse-oximetry circuit 35 and analyzed to determine the athlete's vital signs as described in the above-mentioned patent applications, the contents of which have been incorporated by reference.

The monitoring article 10 optionally can include an LCD 42 that displays information for the athlete. This is primarily for training purposes. In another embodiment, the data-processing circuit 18 avails calculated information through a serial port 40 to an external personal computer, which then displays and analyzes the information using a client-side software application. A battery 37 preferably powers all the electrical components within the monitoring article 10, and the battery 37 is typically a metal hydride battery (typically generating 5V) that can be recharged through a battery recharge interface 44.

The short-range wireless transmitter 38 receives information from the data-processing circuit 18 and transmits this information in the form of a packet through an antenna 39. The external laptop computer or hand-held device (not shown in the figure) features a similar antenna coupled to a matched wireless, short-range receiver that receives the packet.

FIG. 24 shows a graph 59 of a time-dependent signal 60 from the accelerometer 34 that can be ‘fit’ with a waveform 62 from a mathematical model in order to analyze the motion and impact force of the athlete's wrist. In this case, the signal 60 includes a baseline component 63 where the wrist is relatively stationary, and a peak component 64, surrounded on both sides by the baseline component 63, where the wrist is rapidly accelerated and then decelerated. The peak component 64, for example, can correspond to a boxer delivering a punch. The waveform 62 used to fit the signal 60 from the accelerometer 34, once processed by the data-processing circuit, yields properties of the peak and, after processing, the impact of the punch. A number of different algorithms can be used to analyze the waveform for this application. For example, the waveform 62 can yield a magnitude and duration of the peak component 64; these values, in turn, can be compared to a calibration table (coded into firmware running on the data-processing circuit) to estimate the impact of the punch. Alternatively, the magnitude and duration of the peak component 64, once extracted by fitting the waveform 62, can be processed with a first-principles calculation that considers the mass of the athlete's hand and wrist, and combines these with a calculated value of deceleration to estimate the force of the punch. Other algorithms can also be used for this application.

To fit the signal 60 with the waveform 62, the data-processing circuit employs a fitting algorithm, such as a least-squares fitting algorithm, with a known mathematical function that describes the physics of the event at hand. For example, to characterize a punch thrown in a boxing match, the fitting algorithm may employ a simple mathematical function, such as a Gaussian or Lorentzian function, which characterizes the general ‘bell curve’ shape of the peak shown in FIG. 24. These functions are described in detail in the following references, the contents of which are incorporated herein by reference:

Gaussian Function
http://mathworld.wolfram.com/GaussianFunction.html.

Lorenztian Function
http://mathworld.wolfiam.com/LorentzianFunction.html

The components are typically completely covered by the boxing glove 70, as shown in dashed lines in FIG. 22, so that they are not exposed. In addition, the components are housed within a durable, polymer bracelet, and secured to the athlete to prevent slipping during use. When the boxing glove 70 delivers a punch, the accelerometer 34 integrated in the wrist-worn component 11 generates a signal, which is then analyzed as described with reference to FIG. 24 with the data-analysis circuit 18 to determine the impact force of the punch. The data-analysis circuit can additionally count peaks above a pre-determined threshold in the signal to determine the number of punches thrown. Concurrently, the vital-sign monitor 16 connected to the finger-mounted module 13 measures blood flow in the athlete's finger, and sends this information through the cable 12 to the wrist-mounted module 11 for further processing by the data-processing circuit 18. The finger-mounted module 13 generates an optical waveform, described above, that is processed to determine diastolic and systolic blood pressure, heart rate, and pulse oximetry.

In other embodiments, a sports glove worn under a boxing glove 70 can be used for monitoring performance and physiology of a fighter. Such a sport glove is disclosed in co-pending U.S. patent application Ser. No. 11/085,778, filed on Mar. 21, 2005 for a Monitoring Device, Method And System, which is hereby incorporated by reference in its entirety. Such a sports glove can also be used to only monitor the physiology of a fighter in a fighting environment.

In still other embodiments, the above-described system is integrated with a television-broadcasting system so that information measured by the wrist-worn bracelet during a sporting event, e.g. a boxing match, is transmitted along with images from the event. This allows, for example, a boxer's vital signs and punch force to be displayed on a television set along with the boxing match. In this way, the television audience can monitor the match and the condition and performance of the boxer. In other embodiments, information sent from the bracelet is received, processed, integrated into a televised format, and then broadcast with a televised signal. In this way, for example, a boxer's vital signs and punch force can be displayed on a television monitor along with the boxing match. The display, for example, may be a graphical format.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appearing the following appended claims. Therefore, the embodiment of the invention in which an exclusive property or privilege is claimed are defined in the following appended claims.

We claim as our invention:

1. A method for real time monitoring of the performance of two fighters within a fighting environment, the method comprising:
obtaining real time performance data from a first fighter and a second fighter during the fighting event, the performance data comprising the force of a punch;
wirelessly transmitting the performance data for each of the first fighter and the second fighter to a transceiver outside of the fighting environment; and
processing the performance data for each of the fist fighter and the second fighter for display on an electro-optical display device.

2. The method according to claim 1 wherein obtaining real-time performance data from a first fighter and a second fighter during the fighting event comprises:
monitoring a plurality of strike motions of each of the fighters striking at each other during the match; and
converting each of the plurality of strike motions into a digital signal.

3. The method according to claim 1 wherein the performance data further comprises at least one of the speed of a punch, the type of a punch, the contact of a punch and time interval between punches.

4. The method according to claim 1 wherein the two fighters are boxers, and each boxer has a first glove and a second glove, and each of the first glove and the second glove has a motion sensing device positioned within a gauze bandage for monitoring a plurality of strike motions, the gauze bandage positioned under each of the first glove and the second glove.

5. The method according to claim 1 wherein the two fighters are boxers and each boxer has a motion sensing device positioned under the cuff of each glove for monitoring a plurality of strike motions.

6. The method according to claim 1 wherein the two fighters are kick-boxers and each kick boxer has a motion sensing device on each leg and on each wrist of the kick-boxer's body for monitoring a plurality of strike motions.

7. The method according to claim 5 wherein each motion sensing device is an accelerometer, and the accelerometer is in communication with a microprocessor and a wireless transceiver.

8. The method according to claim 4 further comprising a plurality of force sensors positioned about an impact area of each of the first glove and the second glove for each of the fighters.

9. The method according to claim to claim 1 further comprising:
obtaining real time physiology data from the first fighter and the second fighter during the fighting event, the physiology data comprising a pulse oximetry;
wirelessly transmitting the physiology data for each of the first fighter and the second fighter to a transceiver outside of the fighting environment; and
processing the physiology data for each of the fist fighter and the second fighter for display on an electro-optical display device.

10. A system for real time monitoring of the performance of two fighters within a fighting environment, the system comprising:
means for obtaining real time performance data from a first fighter and a second fighter during the fighting event, the performance data comprising the force of a punch;
means for wirelessly transmitting the performance data for each of the first fighter and the second fighter to a transceiver outside of the fighting environment; and
means for processing the performance data for each of the fist fighter and the second fighter for display on an electro-optical display device.

11. The system according to claim 10 wherein
the obtaining real-time performance date means comprises a plurality of monitoring articles attached to each fighter, each of the plurality of monitoring articles comprising
a motion sensing device for monitoring a plurality of strike motions of each of the fighters striking at each other during the match, and
an analog to digital converter for creating a digital signal from a signal for each of the plurality strike motions;
the wireless transmission means comprises a wireless transceiver that receives the digital signal from the analog to digital converter and transmits the digital signal outside of the fighting environment; and
the processing performance data means comprises a computing device positioned outside of the fighting environment, the computing device comprising
a transceiver for receiving the impact force signal from the wireless transceiver of each of the plurality of monitoring articles, and
a microprocessor in communication with the transceiver, the microprocessor processing the digital signal from the wireless transceiver of each of the plurality of monitoring articles to determine the type of punch or kick.

12. The system according to claim 11 wherein the two fighters are boxers and each boxer has a monitoring article positioned under the cuff of each boxing glove for monitoring a plurality of strike motions.

13. The system according to claim 11 wherein the two fighters are kick-boxers and each kick boxer has monitoring article on each leg and on each wrist of the kick-boxer's body for monitoring a plurality of strike motions.

14. The system according to claim 11 wherein the wireless transceiver of each of the plurality of monitoring articles wirelessly transmits an identification signal for the microprocessor of the computing device to identify the origination of the signal.

15. The system according to claim 10 wherein the real-time performance data further comprises at least one of the speed of a punch, the type of a punch, the contact of a punch and time interval between punches.

16. The system according to claim 11 wherein the two fighters are boxers, and each boxer has a first glove and a second glove, and each of the first glove and the second glove has a motion sensing device positioned within a gauze bandage for monitoring a plurality of strike motions, the gauze bandage positioned under each of the first glove and the second glove.

17. The system according to claim 16 further comprising a plurality of force sensors positioned about an impact area of each of the first glove and the second glove for each of the fighters.

18. A method for real time monitoring of the performance of an athlete within an athletic environment, the method comprising:
recording a plurality of information for each of a plurality of recorded motions of an athlete's limb using an accelerometer, the plurality of information comprising the average position of the X and Y axis, the absolute value of the change of X and Y, the range of X and Y, and the zero cross;
monitoring the motion of the athlete's limb during the athletic event using the accelerometer to collect a plurality of information on each of a plurality of monitored motions; and
determining the motion of the athlete's limb by comparing the plurality of information for each of the plurality of monitored motions to the plurality of information for each of the plurality of recorded motions.

19. The method according to claim 18 wherein the athlete is a boxer and the athletic event is a boxing match, wherein determining the motion further comprises deterring the type of punch thrown by the boxer.

20. The method according to claim 19 further comprising wirelessly transmitting the plurality of information on each of a plurality of monitored motions to a computing device positioned outside of a boxing ring during the boxing match, and displaying the type of punch thrown for viewers of the boxing match.
